(19) United States
(12) Patent Application Publication
(10) Pub. No.: US 2026/0068080 A1
(43) Pub. Date: Mar. 5, 2026

(54) DETECTING SYSTEMS IN BAGS

(71) Applicant: Dell Products L.P., Round Rock, TX (US)

(72) Inventors: ADOLFO SANDOR MONTERO, Pflugerville, TX (US); SURAJ M. VARMA, Portland, OR (US)

(21) Appl. No.: 18/820,544

(22) Filed: Aug. 30, 2024

(51) Int. Cl. H05K 7/20; G06F 1/20

(52) U.S. Cl. CPC H05K 7/20209; G06F 1/206

(57) ABSTRACT

Methods and systems for managing a data processing system are provided. In particular, embodiments disclosed herein provide mechanisms for detecting whether a data processing system is stored in a bag, and whether the data processing system is at risk of being negatively impacted by being stored in the bag. When a data processing system is detected as being stored in the bag, one or more in-bag actions may be performed to alleviate a burden placed on the data processing system by the data processing system being in the bag.

### FIELD

Embodiments disclosed herein relate generally to managing data processing systems. More particularly, embodiments disclosed herein relate to systems and methods for managing cooling of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with one or more embodiments.

FIG. 2A shows a block diagram illustrating an example data processing system in accordance with one or more embodiments.

FIG. 2B shows a block diagram illustrating another example of a data processing system in accordance with an embodiment.

FIG. 3 shows a data flow diagram in accordance with one or more embodiments.

FIGS. 4A-4C show flowcharts in accordance with one or more embodiments.

FIG. 5 shows a block diagram illustrating a data processing system in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a data processing system. In particular, embodiments disclosed herein provide a process for detecting whether a data processing system is stored in a bag.

More specifically, in a constrained space such as a bag or other enclosed containers, the amount of air within the constrained space and the air circulation of the air with outside air (e.g., outside the bag/other enclosed containers) are limited. As a result, data processing systems that are stored in such constrained spaces without being fully powered off are at a high risk of overheating, which may cause the data processing systems to either use up more power at a faster rate or fail entirely.

For example, a user may place a data processing system such as a laptop (or other similar portable devices) into a bag after intending to place the data processing system in a sleep or other low power operating state. However, the data processing system may not have properly entered the low power operating state and remains running (e.g., at normal operating levels) while in the bag. As a result, the data processing system may heat up (e.g., due to poor circulation of air within the bag, or the like) and start to consume power at a faster rate or start to fail. When the user later takes the data processing system out of the bag, the data processing system may be in a state (e.g., a low battery state, an empty battery state, an overheated state, or the like) that would cause issues for the user (e.g., by the data processing system being unusable or the data processing system being broken due to overheating).

Even upon successfully entering such intended low power operating states, the data processing system may still be at a substantial risk of overheating if conditions within the bag are not suitable for storage of the data processing system for long periods of times (e.g., over an hour, over half a day, over a day, or the like).

To prevent such issues from occurring after placing a data processing system in a bag (or other similar enclosed space such as a box, a carrying case, a briefcase, or the like), embodiments disclosed herein provide systems and methods for determining (e.g., detecting) whether a still powered-on data processing system is currently stored inside a bag (or other similar enclosed space) using thermal measurements taken by the data processing system.

To prevent the data processing system from running into thermal issues (e.g., overheating, or the like) that will lead to further complications (e.g., faster consumption of battery life, system failure, component failure, or the like), embodiments disclosed herein also determine whether a data processing system that is stored in a bag is properly cooling. Such determination of whether the data processing system is properly cooling within a bag (or other similar enclosed space) also advantageously allows the data processing system to determine its own safety without having to alert a user (e.g., owner) of false alarms (e.g., such as no complications occurring to the data processing system if the data processing system is properly cooling in the bag).

As a result, an improvement in data processing system management technology and user experience technology is achieved by such automatic in bag detection of embodiments disclosed herein. In particular, the data processing system itself will be able to determine whether it will experience any complications (e.g., faster consumption of battery life, system failure, component failure, or the like) within the bag (or other similar enclosed space) that would lead to direct complications for the user (e.g., leading to a broken/failed system, leading to a system that cannot be used when the user is intending to use the system because it has run out of batteries, or the like).

Additionally, embodiments disclosed herein also directly improve the operations and functionalities of the data processing system. In particular, by preventing such complications from happening within the bag (or other similar enclosed space), the overall life and capabilities of the data processing system may advantageously be extended through slower deterioration of the data processing system (e.g., slower deterioration of components due to overheating or the like experienced within the enclosed space) through human-induced causes.

Even further, embodiments disclosed herein also solve a long felt need within this technical field. In particular, there has always been a long felt need to determine whether data processing systems (e.g., namely, portable ones) are being transported in a safe and reliable manner. Furthermore, users of data processing systems (namely, portable systems that are able to be stored within bags or the like) often complain about data processing systems failing, running out of battery/power, or the like, after being placed in bags (or other similar enclosed spaces). In most cases, users often do not even know about such issues that could arise when placing data processing systems within bags (or other similar enclosed spaces) since users believe that these portable data processing systems are designed (and even advertised) to be transported within these bags (e.g., designated laptop bags, carrying cases, briefcase, or the like).

Thus, embodiments disclosed herein solves such long felt needs by providing a mechanism that would ensure users that their devices (e.g., data processing systems) are safe while being transported within such bags (or other similar enclosures/enclosed spaces) that were designed for transporting these devices.

In an embodiment, a computer-implemented method for managing a data processing system is provided. The method may include: obtaining, by the data processing system, system data from a basic input/output system (BIOS) of the data processing system; obtaining, by the data processing system, ambient temperature data from an ambient temperature sensor installed at an air intake portion of the data processing system; determining, by an in-bag detection agent of the data processing system and using the system data and the ambient temperature data to determine, whether the data processing system is stored in a bag; and performing, by the data processing system and in response to determining that the data processing system is stored in the bag, one or more in-bag actions to alleviate a burden placed on the data processing system by the data processing system being in the bag.

Determining whether the data processing system is stored in the bag may include: making a first determination as to whether an in-bag detection is required to be performed; making a second determination, based on a result of the first determination being that the in-bag detection is required to be performed, as to whether the data processing system is stored in the bag; and making a third determination, based on a result of the first determination being that the in-bag detection is not required to be performed, that the data processing system is not stored in the bag.

Making the first determination may include: making a fourth determination, using the system data, that a fan of the data processing system is running; and making a fifth determination, based on the fourth determination, that the in-bag detection is required to be performed.

Making the first determination may include: making a fourth determination, using the system data, that a fan of the data processing system is not running; making a fifth determination, after the fourth determination, that the system data shows that the data processing system is in a standby mode; making a sixth determination, after the fifth determination and using the ambient temperature data, that an ambient temperature of the data processing system is less than an ambient temperature threshold; and making a seventh determination, based on the sixth determination, that performance of the in-bag detection is not needed.

Making the second determination may include: making a fourth determination, using the ambient temperature data, that an ambient temperature of the data processing system has exceeded an ambient temperature threshold; and making a fifth determination, based on the fourth determination, that the data processing system is stored in the bag.

Making the second determination may include: making a fourth determination, using the ambient temperature data, that an ambient temperature of the data processing system is less than an ambient temperature threshold; resetting, based on the fourth determination, an in-bag counter of the data processing system; incrementing, during an in-bag checking period and based on the ambient temperature data, the in-bag counter each time an increase in the ambient temperature is detected; and making a fifth determination, when the in-bag counter exceeds a counter threshold during the in-bag checking period, that the data processing system is stored in the bag.

Making the second determination may further include: making a sixth determination, at any time during the in-bag checking period, that the ambient temperature of the data processing system has exceeded the ambient temperature threshold; making a seventh determination, based on the sixth determination and regardless of a value of the in-bag counter, that the data processing system is stored in the bag.

Making the second determination may further include: making an eighth determination, before the in-bag counter has exceeded the counter threshold, that the in-bag checking period has expired; and resetting, based on the eighth determination, the in-bag counter.

The method may further include obtaining, by the data processing system, a lid check result from a lid sensor installed on the data processing system, the lid check result indicates whether a lid of the data processing system is open or closed. Determining whether the data processing system is stored in the bag is further based on the lid check result.

The one or more in-bag actions comprise at least one of performing a graceful shutdown of the data processing system, alerting a user of the data processing system, or placing the data processing system into a low power mode.

A non-transitory media may include instructions that when executed by a processor cause the computer-implemented method to be performed.

The data processing system may include the non-transitory media and a processor, and may perform the computer-implemented method when the computer instructions are executed by the processor.

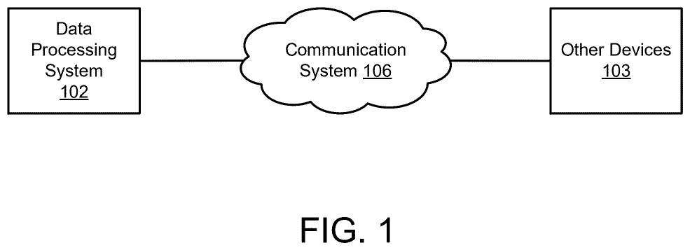

Turning to FIG. 1, a block diagram illustrating a distributed system in accordance with an embodiment is shown. The (distributed) system shown in FIG. 1 may provide computer-implemented services. The computer-implemented services may include any type and quantity of services including, for example data services (e.g., data storage, access and/or control services), communication services (e.g., instant messaging services, video-conferencing services), and/or any other type of service that may be implemented with a computing device.

The computer-implemented services may be provided by one or more components of the system of FIG. 1. For example, data processing system 102 may be implemented as any type of computing device (e.g., desktop computers, mobile phones, tablets, laptops, or the like) that may provide computer-implemented services. For example, the computer-implemented services may include data storage services, instant messaging services, database services, and/or any other type of service that may be implemented with a computing device.

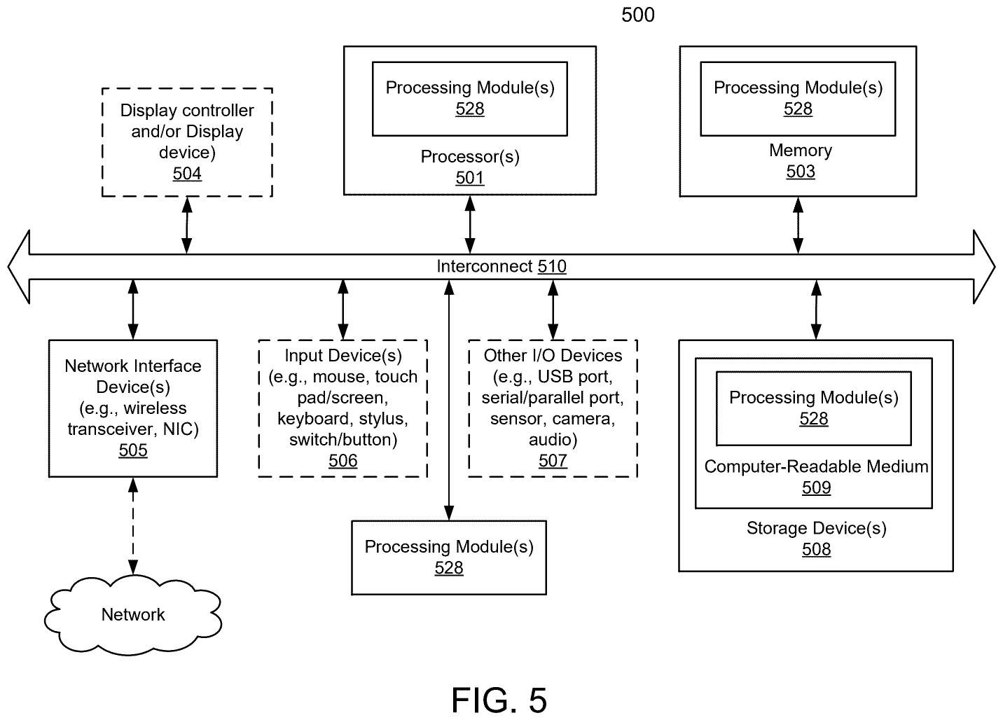

Such computer-implemented services may be provided to one or more users of the data processing system 102 and/or to users of other devices 103 (e.g., via the users of other devices 103 requesting such computer-implemented services from the data processing system 102). Conversely, the other devices 103 may also provide computer-implemented services to the data processing system 102. In embodiments, any of the data processing system 102 and the other devices 103 may implemented as a computing device (e.g., computing device of FIG. 5).

To provide the computer-implemented services, the system of FIG. 1 may include any number of the data processing system 102 and the other devices 103. Data processing system 102 and the other devices 103 may provide the computer-implemented services to their respective users and/or to other devices (not shown). Data processing system 102 and the other devices 103 may provide similar and/or different computer-implemented services. Data processing system 102 and the other devices 103 may also be organized in one or more deployments (e.g., server farms, remote storage environments, Cloud-RAN deployments, or the like) to collectively provide the computer-implemented services.

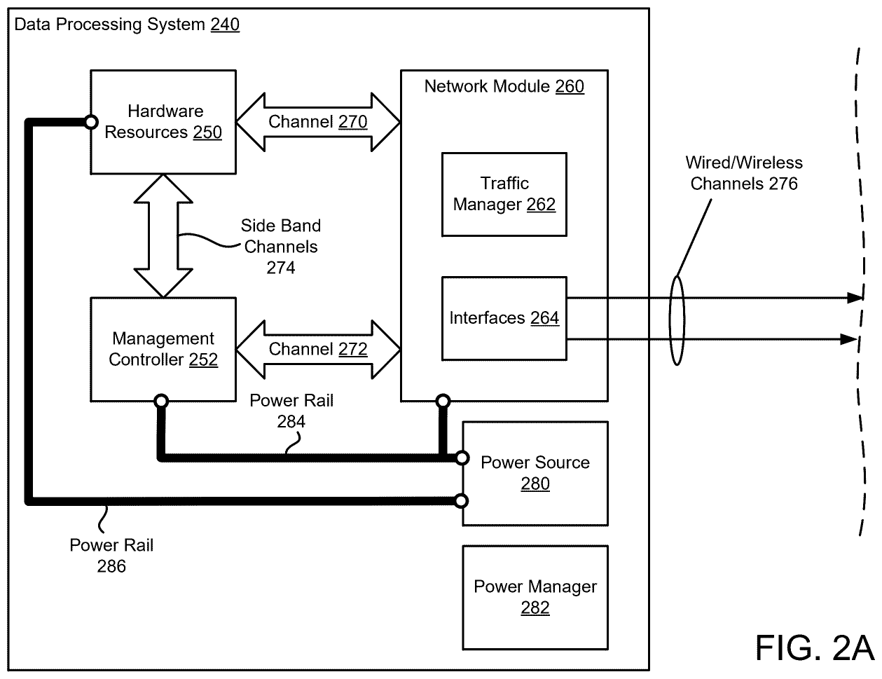

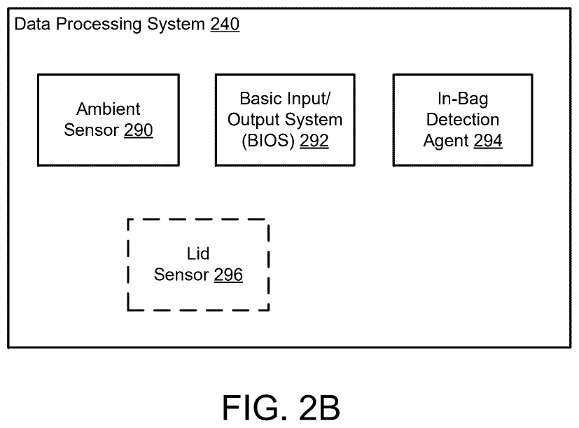

To provide the computer-implemented services, data processing systems 102A-102N may include various hardware components (e.g., processors, memory modules, storage devices, peripheral devices, etc.) and host various software components (e.g., operating systems, application, startup managers such as basic input-output systems, etc.). These hardware and software components (discussed in more detail below in FIG. 2A) may provide the computer-implemented services via their operation.

The software components may be implemented using various types of services. For example, each data processing system of the data processing systems 102A-102N may host various services that provide the computer-implemented service (e.g., application services) and/or that manage the operation of these services (e.g., management services). The aggregate (e.g., combination) of the management and application services may be a complete service that provide desired functionalities.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and/or types of communication protocols (e.g., such as the internet protocol).

While illustrated in FIG. 1 as including a limited number of specific components, a system in accordance with an embodiment may include fewer, additional, and/or different components than those illustrated therein.

Turning to FIG. 2A, a diagram illustrating an example data processing system 240 in accordance with an embodiment is shown. The data processing system 240 shown in FIG. 2A may be similar to data processing system 102 (and/or any of the other devices 103) shown in FIG. 1.

To provide computer-implemented services, data processing system 240 may include any quantity of hardware resources 250. Hardware resources 250 may be in-band hardware components, and may include a processor operably coupled to memory, storage, and/or other hardware components (e.g., ambient sensor 290, in-bag detection agent 294, lid sensor 296 discussed in more detail below in FIG. 2B, sensors, or the like).

In embodiments, the processor (e.g., central processing unit (CPU)) that is part of the hardware resources 250 may be a main processor of the data processing system 240. This main processor may host various management entities such as operating systems (OS), drivers (e.g., OS-based and non-OS based drivers), OS stacks, firmware stacks, network stacks, and/or other software entities that provide various management functionalities. For example, the OS and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 250 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 270 to a communication component, which may then send the packaged communication (in a yet further packaged form, in some embodiments, with various layers of encapsulation being added depending on the network environment outside of data processing system 240) to another device via any number of intermediate networks (e.g., via wired/wireless channels 276 that are part of the networks).

To reduce the likelihood of the applications and/or other in-band entities from being indirectly compromised, data processing system 240 may include management controller 252 and network module 260. Each of these components of data processing system 240 is discussed below.

Management controller 252 may be implemented, for example, using a system on a chip or other type of independently operating computing device (e.g., a microcontroller or the like that is independent from the in-band components, such as hardware resources 250 of a host data processing system 240). Management controller 252 may provide various management functionalities for data processing system 240. For example, management controller 252 may monitor various ongoing processes performed by the in-band components, may manage power distribution, thermal management, and/or may perform other functions for managing data processing system 240. In some embodiments, the management controller 252 may act as the embedded controller of the data processing system 240. In some embodiments, the management controller 252 may be the sole embedded controller of the data processing system 240 (e.g., there is no separate embedded controller as part of the hardware resources 250).

In embodiments, the management controller 252 may be implemented as an embedded controller with separate memory (e.g., random access memory (RAM)) from that of the main processor. The embedded controller may also operate independently from the main processor (e.g., using its own secondary and independent processor) and perform independent functions such as, but not limited to: (i) receiving and processing signals from a keyboard or other input devices of the data processing system 240; (ii) retrieving thermal measurements (e.g., temperature measurements) from various components of the data processing system (e.g., from the sensors that are part of hardware resources 250), or the like); (iii) using the thermal measurements to control one or more fans installed within the data processing system 240 and/or to throttle the main processor; or the like.

In embodiments, the management controller 252 (acting as an embedded controller) may be configured to have sole control over all thermal readings (e.g., temperature measurements) of the thermal sensors installed in the data processing system 240. This advantageously creates (through the embedded controller) a single interface (e.g., a single API or the like) that can be called on (e.g., by the stacks of the main processor) when thermal readings are needed for thermal management of the data processing system 240. Use of the management controller 252 as the single interface for thermal readings advantageously provides improved software transparency and a cleaner architecture for the data processing system 240. When other components (e.g., the main processor, the in-bag detection agent 294, or the like) need to use the thermal readings, they may obtain the thermal readings from the management controller 252 (e.g., using an API call or the like).

In embodiments, to provide its functionalities, management controller 252 may be operably connected to various components via sideband channels 274 (in FIG. 2A, a limited number of sideband channels are included for illustrative purposes, it will be appreciated that management controller 252 may communicate with other components via any number of sideband channels). The sideband channels may be implemented using separate physical channels, and/or with a logical channel overlay over existing physical channels (e.g., logical division of in-band channels). The sideband channels may allow management controller 252 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities. For example, the management controller may use sideband channels (e.g., inter-integrated circuit (I2C)/improved inter-integrated circuit (I3C) interfaces/channels, analog-to-digital converter (ADC) channels, or the like).

For example, to reduce the likelihood of indirect compromise of an application hosted by hardware resources 250, management controller 252 may enable information from other devices to be provided to the application without traversing the network stack and/or management entities of hardware resources 250. To do so, the other devices may direct communications including the information to management controller 252.

Management controller 252 may then, for example, send the information via sideband channels 274 to hardware resources 250 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 252 may be operably connected to communication components of data processing system 240 via separate channels (e.g., 272) from the in-band components, and may implement or otherwise utilize a distinct and independent network stack (e.g., TCP/IP). Consequently, management controller 252 may communicate with other devices independently of any of the in-band components (e.g., does not rely on any hosted software, hardware components, etc.). Accordingly, compromise of any of hardware resources 250 and hosted components may not result in indirect compromise of any management controller 252, and entities hosted by management controller 252.

To facilitate communication with other devices, data processing system 240 may include network module 260. Network module 260 may provide communication services for in-band components and out-of-band components (e.g., management controller 252) of data processing system. To do so, network module 260 may include traffic manager 262 and interfaces 264.

Traffic manager 262 may include functionality to (i) discriminate traffic directed to various network endpoints advertised by data processing system 240, and (ii) forward the traffic to/from the entities associated with the different network endpoints. For example, to facilitate communications with other devices, network module 260 may advertise different network endpoints (e.g., different media access control address/internet protocol addresses) for the in-band components and out-of-band components. Thus, other entities may address communications to these different network endpoints. When such communications are received by network module 260, traffic manager 262 may discriminate and direct the communications accordingly (e.g., over channel 270 or channel 272, in the example shown in FIG. 2A, it will be appreciated that network module 260 may discriminate traffic directed to any number of data units and direct it accordingly over any number of channels).

Accordingly, traffic directed to management controller 252 may never flow through any of the in-band components. Likewise, outbound traffic from the out-of-band component may never flow through the in-band components.

Thus, if in-band components of data processing system 240 are unsecured and/or compromised (e.g., by a malicious party), then the computing instructions sent using out-of-band components and via out-of-band communication channels may be less likely to be intercepted and/or modified (e.g., by the malicious party), and the operation of data processing system 240 may be more likely to be updated according to its reported location.

To support inbound and outbound traffic, network module 260 may include any number of interfaces 264. Interfaces 264 may be implemented using any number and type of communication devices which may each provide wired and/or wireless communication functionality. For example, interfaces 264 may include a wireless wide area network (WWAN) card, a Wi-Fi card, a wireless local area network card, a wired local area network card, an optical communication card, and/or other types of communication components. These components may support any number of wired/wireless channels 276.

Thus, from the perspective of an external device, the in-band components and out-of-band components of data processing system 240 may appear to be two independent network entities, that may be independently addressable and/or otherwise unrelated to one another.

To facilitate management of data processing system 240 over time, hardware resources 250, management controller 252 and/or network module 260 may be positioned in separately controllable power domains. By being positioned in these separate power domains, different subsets of these components may remain powered while other subsets are unpowered.

For example, management controller 252 and network module 260 may remain powered while hardware resources 250 is unpowered. Consequently, management controller 252 may remain able to communicate with other devices even while hardware resources 250 are inactive. Similarly, management controller 252 may perform various actions while hardware resources 250 are not powered and/or are otherwise inoperable, unable to cooperatively perform various process, are compromised, and/or are unavailable for other reasons. Therefore, if hardware resources 250 become unavailable (e.g., due to being unpowered), then out-of-band components may remain powered, allowing network module 260 to continue to generate location data for data processing system 240.

To implement the separate power domains, data processing system 240 may include a power source (e.g., 280) that separately supplies power to power rails (e.g., power rail 284, power rail 286) that power the respective power domains. Power from the power source (e.g., a power supply, battery, etc.) may be selectively provided to the separate power rails to selectively power the different power domains. A power manager (e.g., 282) that may manage power from power source 280 may be supplied to the power rails. Management controller 252 may cooperate with power manager 282 to manage supply of power to these power domains.

In FIG. 2A, an example implementation of separate power domains using power rails 284-286 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

Turning now to FIG. 2B, FIG. 2B shows another example of the data processing system 240 shown in FIG. 2A. In particular, FIG. 2B shows an abridged (e.g., simplified) version of the data processing system 240 with certain components visually removed for simplicity. Said another way, although not shown in FIG. 2B, the data processing system 240 of FIG. 2B still includes all of the components shown in FIG. 2A.

As shown in FIG. 2B, data processing system 240 includes an ambient sensor 290, a basic input/output system (BIOS) 292, an in-bag detection agent 294, and (optionally) a lid sensor 296. Each of these components will be described below.

Although a bag is used as the specific example of an enclosure/enclosed space in the descriptions of FIGS. 2B-4C, one of ordinary skill in the art would appreciate the enclosure/enclosed space is not limited to just a bag. Any type of object (e.g., a briefcase, a carrying case, a box, or the like) that is able to completely surround a data processing system and that can be used to transport the data processing system once the data processing system is placed within may also be considered an enclosure/enclosed space within departing from the scope of embodiments disclosed herein.

In particular, in the context of one or more embodiments disclosed herein, the term “bag” as used in the claims and specification should not be limited to its ordinary and/or customary meaning (e.g., its normally accepted dictionary meaning), but instead be defined as any type of physical container, enclosure, or the like with an enclosed space within that is able to accommodate and fully or partially surround the one or more data processing systems.

Ambient sensor 290 may be any type of physical sensor that is configured (e.g., designed) to conduct thermal measurements. Said another way, ambient sensor 290 may be any type of sensor that can, directly or indirectly, obtain a temperature value. In embodiments, the data processing system 240 may have multiple ones of the ambient sensor 290.

In embodiments, ambient sensor 290 may be placed (e.g., disposed, installed, or the like) at an opening on a casing (or housing, chassis, or the like) of the data processing system 240 that would expose the ambient sensor 290 to an ambient (e.g., surrounding, external, or the like) environment of the data processing system 240. For example, the ambient sensor 290 may be installed at an air vent (e.g., an air intake portion, an air outlet portion, a combination thereof, or the like) of a data processing system.

Alternatively, the ambient sensor 290 may be installed anywhere within or on an external surface of the data processing system 240 (namely, a housing, casing, chassis, cover, or the like) of the data processing system 240 as long as the ambient sensor 290 is exposed to an ambient (e.g., surrounding, external, or the like) environment of the data processing system 240 in a capacity that would allow the ambient sensor 290 to obtain a thermal reading (e.g., a temperature of the ambient environment.

In embodiments, the ambient sensor 290 may be part of hardware resources 250 of data processing system 240 and may be powered by any component within the data processing system 240 capable of providing power to the ambient sensor 290 (e.g., the main processor/motherboard on which the main processor is installed, the power supply, the management controller 252, or the like).

The basic input/output system (BIOS) 292 may be a program (e.g., firmware) a computer's microprocessor (e.g., the main processor of the data processing system 240) uses to start the computer system after it is powered on. The BIOS 292 may be configured to contain system data (e.g., data indicating whether the system is in a lower power state or the like). For example, the BIOS 292 may have, among other types of system data, an S0ix (or other similar) indication showing that the data processing system is in a low power operating state (e.g., in a standby mode, in a sleep mode, in an idle state, or the like).

In embodiments, the BIOS 292 may also contain system log data that is used to record the various operations (and when each operation occurred) of the data processing system 240.

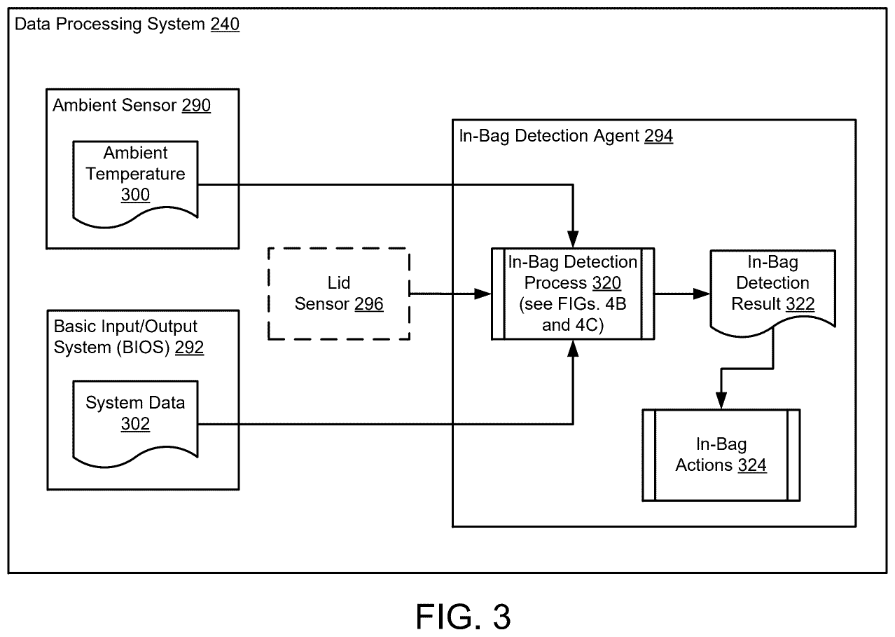

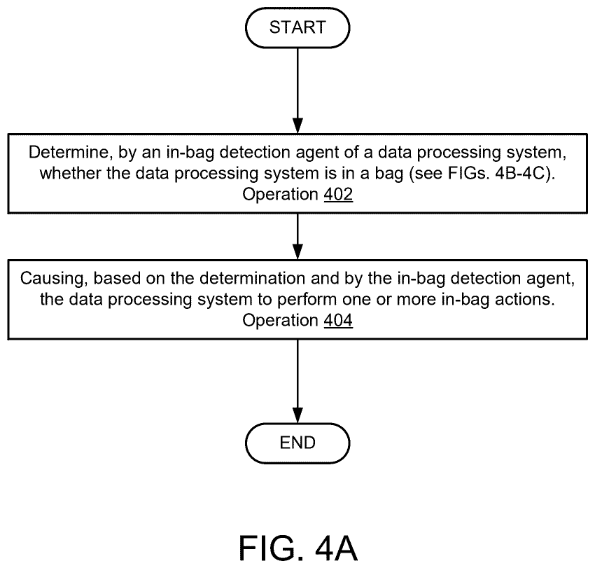

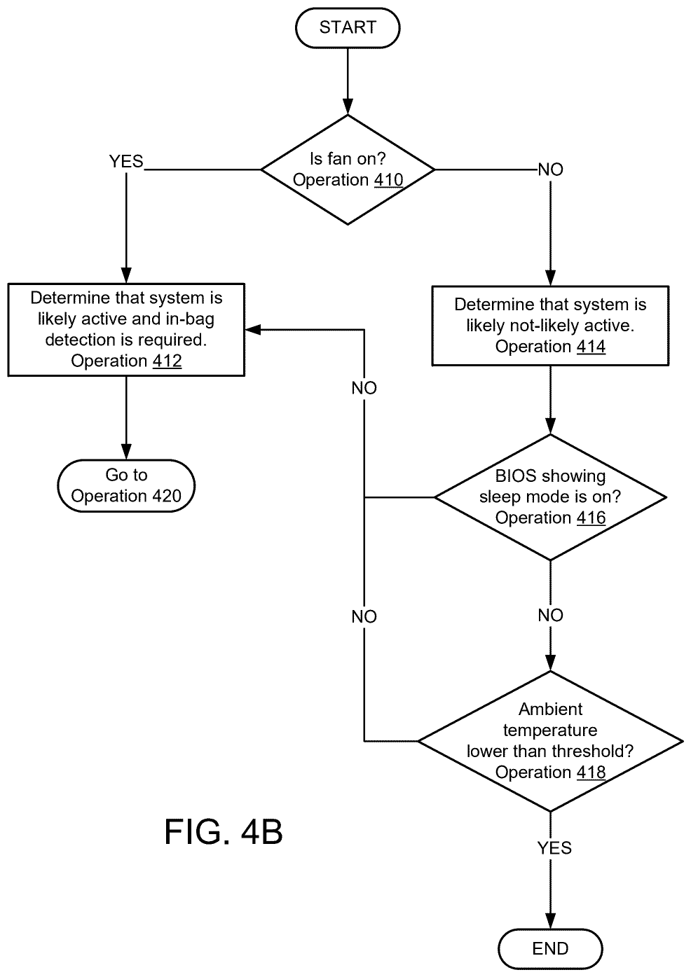

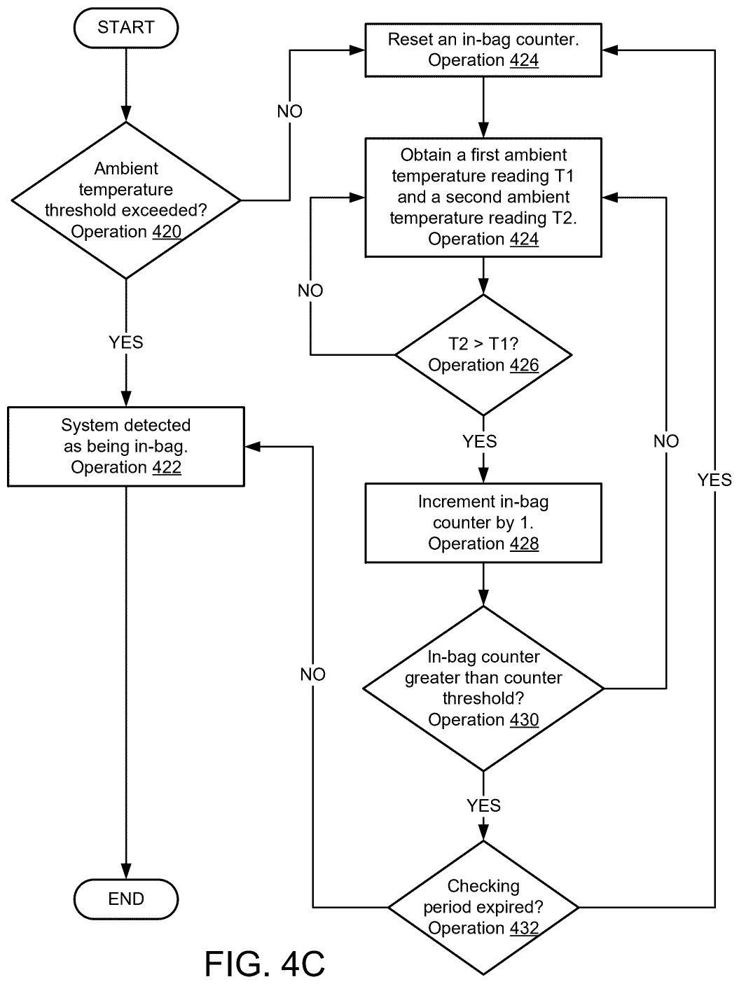

In-bag detection agent 294 may be configured using hardware, software, or a combination of both thereof. In particular, in-bag detection agent 294 may be configured to detect (e.g., determine) whether the data processing system is stored in a bag. Additional details of the detection by the in-bag detection agent 294 is discussed below in reference to FIGS. 3 and 4A-4C.

In embodiments, in-bag detection agent 294 may be implemented using (e.g., individually) the main processor, the management controller 252, an integrated circuit (IC) (e.g., including its own processor and memory) completely separate from the main processor and the management controller 252, or may be implemented as a combination of any of these components working in unison.

For example, in one example implementation of embodiments disclosed herein, the in-bag detection operations/processes (e.g., to be discussed below in reference to FIGS. 3 and 4A-4C) of the in-bag detection agent 294 may be integrated into existing firmware of the management controller 252 (e.g., by adding additional functions to already existing functions and operations of the management controller 252). Alternatively, the in-bag detection operations/processes of the in-bag detection agent 294 may be realized (i.e., implemented) using any other of the components (individually or in combination) discussed in the previous paragraph without departing from the scope of embodiments disclosed herein.

Lid sensor 296 may be any type of physical (or virtual) sensor (or collection of sensors) that is able detect whether a lid of the data processing system 240 (namely, in the event the data processing system 240 is a laptop computer or the like with a closable lid) is open or shut. For example, the lid sensor may be, but is not limited to, a hall sensor.

To further clarify embodiments disclosed herein, a data flow diagram in accordance with one or more embodiments disclosed herein is shown in FIG. 3. In these diagrams, flows of data and processing of data are illustrated using different sets of shapes. A first set of shapes (e.g., 300, 302, 322 etc.) is used to represent data structures (e.g., files, data packets, or the like), a second set of shapes (e.g., 320. 324, etc.) is used to represent processes performed using and/or that generate data, and a third set of shapes (e.g., 240, 290, 292, 294 296, etc.) is used to represent the components (e.g., the devices, hardware and/or software components, or the like discussed above in reference to FIGS. 1A-2B) that perform the processes shown using the second set of shapes.

As shown in FIG. 3, ambient temperature 300 may be obtained (e.g., measured, calculated, deduced, or the like) by the ambient sensor 290. Similarly, BIOS 292 may include system data 302 (e.g., system log data, system state indicators, or the like).

Such ambient temperature 300 and system data 302 may be obtained by the in-bag detection agent 294 and ingested into an in-bag detection process 320, which will be discussed in more detail below in FIGS. 4B and 4C). In embodiments, in-bag detection process 320 is configured to use the ambient temperature 300 and system data 302 to determine whether the data processing system 240 is stored in a bag.

Additionally, the in-bag detection agent 294 may also be configured to receive data, directly or indirectly, from the lid sensor 296. The data from the lid sensor 296 may indicate whether a lid of the data processing system 240 is in an opened or closed state. This data from the lid sensor 296 may also be used, in combination with the ambient temperature 300 and the system data 302, by the in-bag detection agent 294 (as part of in-bag detection process 320) to determine whether the data processing system is in the bag.

A result of the whether the data processing system 240 is stored in the bag is generated (e.g., output) by in-bag detection process 320 as an in-bag detection result 322, which indicates (e.g., to in-bag detection agent 294 and/or other components of the data processing system 240) whether the data processing system 240 is stored in a bag and/or is at risk of overheating (or running into other complications such as faster consumption of power due to the system heating up but not to the point of overheating, or the like).

Using the in-bag detection results 322, the in-bag detection agent 294 may cause the data processing system 240 to perform one or more in-bag actions 324. For example, the one or more in-bag actions 324 may include, but is not limited to: (i) alerting a user of the data processing system 240 using one or more audio and/or haptic feedbacks (e.g., causing the data processing system 240 to vibrate, play an alert/warning sound, or the like); (ii) transmit a notification to another device (e.g., a mobile phone or the like) of the user to let the user become aware that the data processing system 240 is within the bag and potentially may overheat or experience other similar complications; (iii) automatically switch the data processing system 240 into a low power state (e.g., a sleep state); (iv) automatically perform a graceful shutdown of the data processing system 240; or the like.

For example, consider the following first use case of embodiments disclosed herein. In this first use case, a user closes a lid of a laptop and places the laptop into a backpack to take home. The commute back home is long and the laptop has not been put into (or has not properly entered as an effect of closing the lid) a sleep mode. As a result, the laptop slowly heats up inside the backpack due to a lack of air flow within the backpack. The in-bag detection agent 294 detects such monotonic increase in temperature inside the bag (e.g., using the ambient temperature 300 measured by the ambient sensor 290) and automatically forces the laptop to hibernate.

As another example, consider the following second use case of embodiments disclosed herein. A user takes their laptop out of a bag and places the laptop on a tabletop. Because the ambient temperature around the laptop does not rise (e.g., rise steadily in a monotonic manner), the in-bag detection agent 294 is not triggered and the laptop continues normal operations.

One of ordinary skill would appreciate that the above first and second example use cases are meant solely for illustrative and explanatory purposes and are not meant to limit the scope of this application (e.g., the scope of embodiments disclosed herein) in any way or manner.

Any of the processes illustrated using the second set of shapes (shown in FIG. 3) may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

As discussed above, the components of FIGS. 1-3 may perform various methods for managing a data processing system. FIG. 4 illustrates an example method that may be performed by the components of FIGS. 1-3. For example, any of the data processing system 102, and/or the other devices 103 shown in FIG. 1 may include components (e.g., shown in FIGS. 2A-2B) that are capable of performing all or a portion of the method of FIG. 4. In the diagram discussed below and shown in FIG. 4, any of the operations may be repeated, performed in different orders, and/or performed in parallel with or in a partially overlapping in time manner with other operations.

In Operation 402, and as discussed above in reference to FIGS. 2B-3, an in-bag detection agent of a data processing system may determine (e.g., detect) whether the data processing system is in a bag. Additional details regarding the in-bag detection process performed by the in-bag detection agent are discussed in more detail in reference to FIGS. 4B and 4C.

In Operation 404, and as discussed above in reference to FIGS. 2B-3, the in-bag detection agent may cause (based on the results of the determination in Operation 402), the data processing system to perform one or more in-bag actions.

The method of FIG. 4A may end following operation 404.

Turning now to FIGS. 4B-4C, the in-bag detection process 320 will now be described in more detail. Any other types of processes/method (similar not completely identical to that disclosed in FIGS. 4B-4C) are able to be used to determine whether the data processing system is in a bag using the ambient temperature and system data may also be used without departing from the scope of embodiments disclosed herein.

FIG. 4B shows a method for determining (e.g., automatically by the in-bag detection agent of the data processing system) whether in-bag detection is even required.

In Operation 410, a determination is made (e.g., by the in-bag detection agent) to determine whether one or more fans (e.g., computer fans, or the like) data processing system is on (e.g., running).

In response to determining that a fan of the data processing system on (i.e., YES in Operation 410), the method of FIG. 4B proceeds to Operation 412 where is it determined that the data processing system is likely active (e.g., powered on) and that in-bag detection by the in-bag detection agent is required (namely, as a result of the data processing system likely being active).

More specifically, one or more fans being on may indicate to the in-bag detection agent that there is power being supplied to the data processing system (e.g., the data processing system in powered on, albeit being in a low power state such as a sleep mode, hibernation mode, or the like). Because the data processing system is powered on, there is a risk that the data processing system may heat up if placed in a bag. Thus, in-bag detection is required to be performed by the in-bag detection agent.

In embodiments, an indication of the fan being on may be received in the form of system data from the BIOS. The indication of the fan being may also be received from any other component (e.g., the management controller 252 of the like) within the data processing system that has control over an operation of the fan(s).

Once it has been determined that the in-bag detection is required in Operation 412, the method may proceed to Operation 420 of the method of FIG. 4C.

Alternatively, in response to determine that no fans are on (i.e., NO in Operation 410), the in-bag detection agent determines (in Operation 414) that the data processing system is not-likely active.

In Operation 416, the in-bag detection agent may make a determination as to whether the BIOS is showing that the data processing system is in a sleep (or other similar low power) mode. The sleep mode may be determined by obtaining an S0ix notification/indicator from the BIOS in the form of system data obtained from the BIOS.

In response to the system data from the BIOS showing that the data processing system is not in a sleep (or other similar low power) mode (i.e., NO in Operation 416), the method proceeds to Operation 412 (and subsequently to Operation 420 of the method of FIG. 4C).

Alternatively, in response to the system data from the BIOS showing that the data processing system is in a sleep (or other similar low power) mode (i.e., YES in Operation 416), the method proceeds to Operation 418 where the in-bag detection agent makes a determination as to whether an ambient temperature (e.g., measured by the ambient sensor of the data processing system) of the data processing system is lower (e.g., less than) a threshold value (e.g., an in-bag detection requirement temperature threshold value).

In embodiments, the in-bag detection requirement temperature threshold value may be any value set by a user and/or manufacturer of the data processing system, and may be a value determined by the user and/or manufacturer as a temperature where the data processing system is not at risk of heating up within the bag.

In response to determining that the ambient temperature of the data processing system is not lower than the threshold (i.e., NO in Operation 418), the method proceeds to Operation 412 (and subsequently to Operation 420 of the method of FIG. 4C). Alternatively (i.e., YES in Operation 418), the method of FIG. 4B may end following Operation 418.

In embodiments, the method of FIG. 4B may be repeated (after ending and starting over at Operation 410) at a predetermined interval (e.g., every 10 seconds, or the like) set by user and/or manufacturer of the data processing system.

Turning now to FIG. 4C, FIG. 4C shows a method for determining whether the data processing system is stored in a bag (and potentially heating up to a point where the data processing system will be negatively impacted by the rising temperatures within and external to the data processing system).

In Operation 420, a determination is made (e.g., by in-bag detection agent of the data processing system) as to whether an ambient temperature threshold has been exceeded. The ambient temperature threshold may be any value set by a user and/or manufacturer of the data processing system, and may be a value determined by the user and/or manufacturer as a temperature value where the data processing system is at risk of being negatively impacted by being stored in the bag.

In embodiments, the ambient temperature threshold may be a larger (e.g., higher) value than the in-bag detection requirement temperature threshold value used in Operation 418 of FIG. 4B.

In response to determining that the ambient temperature threshold has been exceeded (i.e., YES in Operation 420), the in-bag detection agent determines that the system is stored in a bag and that one or more of the in-bag actions (e.g., 324 of FIG. 3) would need to be performed to alleviate a burden placed on the data processing system by the data processing system being stored in the bag.

Once the in-bag actions are performed (e.g., as part of Operation 422), the method of FIG. 4C may end following Operation 422.

Alternatively, in response to determining that the ambient temperature threshold has not yet been exceeded (i.e., NO in Operation 420), the method proceeds to Operation 424 where the in-bag detection agent resets an in-bag counter. In embodiments, the in-bag counter may be any numerical counter that is designed to start at one whole negative or positive integer and end at another whole negative or positive integer. For example, the in-bag counter may start at 0 and end at 10 (with 10 being the counter threshold (e.g., maximum)).

Once the in-bag counter is reset, the method proceeds to Operation 424 where a first ambient temperature reading (e.g., T1) and a second ambient temperature reading (e.g., T2) is obtained (e.g., from the ambient sensor). The first ambient temperature reading (or simply “first ambient temperature”) may be taken at an earlier point in time (e.g., at Operation 420) than the second ambient temperature reading (or simply “second ambient temperature”) (e.g., at a preset interval/time after Operation 420).

In Operation 426, T1 is compared to T2 to determined whether T2 is greater than T1. This comparison reveals whether the ambient temperature around the data processing system has increased (e.g., since Operation 420 or the like).

In response to determine that T2 is not greater than T1 (i.e., NO in Operation 424), the method returns to Operation 424 where two ambient temperature readings are again obtained. For example, when the method returns to Operation 424 from Operation 426, the previous value of T2 before the new value for T1 and a new temperature reading is obtained as the new value of T2. Once the new values are obtained, the two temperatures are again compared to determine whether an ambient temperature around the data processing system has increased. Said another way, Operations 424 and 426 are repeated until an increase in the ambient temperature is detected.

Alternatively, in response to determine that T2 being greater than T1 (i.e., YES in Operation 424, and an increase in the ambient temperature has been detected), the method proceeds to Operation 428 where the in-bag counter is incremented by one (“1”).

Once the in-bag counter has been incremented by one in Operation 428, the method proceeds to Operation 430 where a determination is made as to whether the in-bag counter is greater (e.g., has exceeded) the counter threshold.

In response to determining that the counter threshold of the in-bag counter has not been exceeded (i.e., NO in Operation 430), Operations 424 through 428 of the method of FIG. 4C is repeated until it is determined that the in-bag counter has been exceeded.

Alternatively, in response to determining that the counter threshold of the in-bag counter has been exceeded (i.e., YES in Operation 430), the method proceeds to operation 432 where a determination is made as to whether a checking period (e.g., a temperature increase checking period) has expired.

In embodiments, the temperature checking period may be any amount of time set by a user and/or manufacturer of the data processing system, and may be a value (e.g., number) determined by the user and/or manufacturer as an amount of time where the data processing system is at risk of being negatively impacted by being stored in the bag while heating up (e.g., in a monotonic increase manner).

In response to determining that the temperature checking period has expired (i.e., YES in Operation 432), the method may return and start over from Operation 424. Alternatively, in response to determining that the temperature checking period has not expired (i.e., NO in Operation 432), the method may proceed to already discussed Operation 422 (and subsequently end following performance of Operation 422).

In embodiments, at any time during performance of the method of FIG. 4C (e.g., during any part of Operations 424-432), the in-bag detection agent may continuously compare any obtained ambient temperature value to the ambient temperature threshold (similarly to that in Operation 420). In the event that any obtained ambient temperature value exceeds the ambient temperature threshold, the method will automatically proceed to Operation 422 (regardless of any of the results in Operations 424-430) and subsequently end following performance of Operation 422.

Additionally, at any time during the Operations of the methods of FIGS. 4B-4C, if the in-bag detection agent receives sensor data from a lid sensor indicating that a lid of the data processing system is open, the methods of FIGS. 4B-4C may end immediately with the in-bag detection agent determining that the data processing system may not be stored in the bag. However, embodiments herein are not limited to this implementation as there is a possibility that the lid of the data processing system may not be properly closed when the data processing system is placed in the bag.

Any of the components illustrated in FIGS. 1-4C may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. However, it is to be understood that additional components may be present in certain implementations and furthermore, different arrangement of the components shown may occur in other implementations.

System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-508 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like.

More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets.

Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random-access memory (RAM), dynamic RAM (DRAM), synchronous DRAM (SDRAM), static RAM (SRAM), or other types of storage devices. Memory 503 may store information including sequences of instructions that are executed by processor 501, or any other device.

For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs, or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system, the method comprising:
obtaining, by the data processing system, system data from a basic input/output system (BIOS) of the data processing system;
obtaining, by the data processing system, ambient temperature data from an ambient temperature sensor installed at an air intake portion of the data processing system;
determining, by an in-bag detection agent of the data processing system and using the system data and the ambient temperature data to determine, whether the data processing system is stored in a bag; and
performing, by the data processing system and in response to determining that the data processing system is stored in the bag, one or more in-bag actions to alleviate a burden placed on the data processing system by the data processing system being in the bag.

2. The method of claim 1, wherein determining whether the data processing system is stored in the bag comprises:
making a first determination as to whether an in-bag detection is required to be performed;
making a second determination, based on a result of the first determination being that the in-bag detection is required to be performed, as to whether the data processing system is stored in the bag; and
making a third determination, based on a result of the first determination being that the in-bag detection is not required to be performed, that the data processing system is not stored in the bag.

3. The method of claim 2, wherein making the first determination comprises:
making a fourth determination, using the system data, that a fan of the data processing system is running; and
making a fifth determination, based on the fourth determination, that the in-bag detection is required to be performed.

4. The method of claim 2, wherein making the first determination comprises:
making a fourth determination, using the system data, that a fan of the data processing system is not running;
making a fifth determination, after the fourth determination, that the system data shows that the data processing system is in a standby mode;
making a sixth determination, after the fifth determination and using the ambient temperature data, that an ambient temperature of the data processing system is less than an ambient temperature threshold; and
making a seventh determination, based on the sixth determination, that performance of the in-bag detection is not needed.

5. The method of claim 2, wherein making the second determination comprises:
making a fourth determination, using the ambient temperature data, that an ambient temperature of the data processing system has exceeded an ambient temperature threshold; and
making a fifth determination, based on the fourth determination, that the data processing system is stored in the bag.

6. The method of claim 2, wherein making the second determination comprises:
making a fourth determination, using the ambient temperature data, that an ambient temperature of the data processing system is less than an ambient temperature threshold;
resetting, based on the fourth determination, an in-bag counter of the data processing system;
incrementing, during an in-bag checking period and based on the ambient temperature data, the in-bag counter each time an increase in the ambient temperature is detected; and
making a fifth determination, when the in-bag counter exceeds a counter threshold during the in-bag checking period, that the data processing system is stored in the bag.

7. The method of claim 6, wherein making the second determination further comprises:
making a sixth determination, at any time during the in-bag checking period, that the ambient temperature of the data processing system has exceeded the ambient temperature threshold; and
making a seventh determination, based on the sixth determination and regardless of a value of the in-bag counter, that the data processing system is stored in the bag.

8. The method of claim 7, wherein making the second determination further comprises:
making an eighth determination, before the in-bag counter has exceeded the counter threshold, that the in-bag checking period has expired; and
resetting, based on the eighth determination, the in-bag counter.

9. The method of claim 1, wherein the method further comprises:
obtaining, by the data processing system, a lid check result from a lid sensor installed on the data processing system, the lid check result indicates whether a lid of the data processing system is open or closed,
wherein determining whether the data processing system is stored in the bag is further based on the lid check result.

10. The method of claim 1, wherein the one or more in-bag actions comprise at least one of performing a graceful shutdown of the data processing system, alerting a user of the data processing system, or placing the data processing system into a low power mode.

11. A non-transitory machine-readable medium having instructions stored therein, which when executed by a processor, cause the processor to perform operations for managing a data processing system, the operations comprising:
obtaining, by the data processing system, system data from a basic input/output system (BIOS) of the data processing system;
obtaining, by the data processing system, ambient temperature data from an ambient temperature sensor installed at an air intake portion of the data processing system;
determining, by an in-bag detection agent of the data processing system and using the system data and the ambient temperature data to determine, whether the data processing system is stored in a bag; and
performing, by the data processing system and in response to determining that the data processing system is stored in the bag, one or more in-bag actions to alleviate a burden placed on the data processing system by the data processing system being in the bag.

12. The non-transitory machine-readable medium of claim 11, wherein determining whether the data processing system is stored in the bag comprises:
making a first determination as to whether an in-bag detection is required to be performed;
making a second determination, based on a result of the first determination being that the in-bag detection is required to be performed, as to whether the data processing system is stored in the bag; and
making a third determination, based on a result of the first determination being that the in-bag detection is not required to be performed, that the data processing system is not stored in the bag.

13. The non-transitory machine-readable medium of claim 12, wherein making the first determination comprises:
making a fourth determination, using the system data, that a fan of the data processing system is running; and
making a fifth determination, based on the fourth determination, that the in-bag detection is required to be performed.

14. The non-transitory machine-readable medium of claim 12, wherein making the first determination comprises:
making a fourth determination, using the system data, that a fan of the data processing system is not running;
making a fifth determination, after the fourth determination, that the system data shows that the data processing system is in a standby mode;
making a sixth determination, after the fifth determination and using the ambient temperature data, that an ambient temperature of the data processing system is less than an ambient temperature threshold; and
making a seventh determination, based on the sixth determination, that performance of the in-bag detection is not needed.

15. The non-transitory machine-readable medium of claim 12, wherein making the second determination comprises:
making a fourth determination, using the ambient temperature data, that an ambient temperature of the data processing system has exceeded an ambient temperature threshold; and
making a fifth determination, based on the fourth determination, that the data processing system is stored in the bag.

16. A data processing system comprising:
a processor; and
a memory coupled to the processor, the memory storing instructions that, when executed by the processor, causes the data processing system to perform operations for managing the data processing system, the operations comprising:
obtaining system data from a basic input/output system (BIOS) of the data processing system;
obtaining ambient temperature data from an ambient temperature sensor installed at an air intake portion of the data processing system;
determining, by an in-bag detection agent of the data processing system and using the system data and the ambient temperature data to determine, whether the data processing system is stored in a bag; and
performing, in response to determining that the data processing system is stored in the bag, one or more in-bag actions to alleviate a burden placed on the data processing system by the data processing system being in the bag.

17. The data processing system of claim 16, wherein determining whether the data processing system is stored in the bag comprises:
making a first determination as to whether an in-bag detection is required to be performed;
making a second determination, based on a result of the first determination being that the in-bag detection is required to be performed, as to whether the data processing system is stored in the bag; and
making a third determination, based on a result of the first determination being that the in-bag detection is not required to be performed, that the data processing system is not stored in the bag.

18. The data processing system of claim 17, wherein making the first determination comprises:
making a fourth determination, using the system data, that a fan of the data processing system is running; and
making a fifth determination, based on the fourth determination, that the in-bag detection is required to be performed.

19. The data processing system of claim 17, wherein making the first determination comprises:
making a fourth determination, using the system data, that a fan of the data processing system is not running;
making a fifth determination, after the fourth determination, that the system data shows that the data processing system is in a standby mode;
making a sixth determination, after the fifth determination and using the ambient temperature data, that an ambient temperature of the data processing system is less than an ambient temperature threshold; and
making a seventh determination, based on the sixth determination, that performance of the in-bag detection is not needed.

20. The data processing system of claim 17, wherein making the second determination comprises:
making a fourth determination, using the ambient temperature data, that an ambient temperature of the data processing system has exceeded an ambient temperature threshold; and
making a fifth determination, based on the fourth determination, that the data processing system is stored in the bag.
